(19) United States
(12) Patent Application Publication
(10) Pub. No.: US 2008/0023952 A1
(43) Pub. Date: Jan. 31, 2008

(54) Adjustable energy absorbing device for a collapsible steering column

(76) Inventors: Marvin V. Manwaring, Clio, MI (US); Richard K. Riefe, Saginaw, MI (US); Ravi Ravindra, Saginaw, MI (US); Melvin L. Tinnin, Clio, MI (US); Brad M. MacDonald, Bay City, MI (US)

Correspondence Address: DELPHI TECHNOLOGIES, INC., M/C 480-410-202, PO BOX 5052, TROY, MI, 48007, US

(21) Appl. No.: 11/496,380

(22) Filed: Jul. 31, 2006

(51) Int. Cl. B62D 1/00

(52) U.S. Cl. 280/777

(57) ABSTRACT

A collapsible steering column assembly having an outer jacket and an inner jacket movable relative to the outer jacket is disclosed. The assembly includes an energy absorbing device having a support disposed on the outer jacket for supporting a first anvil and a second anvil in relative proximity to each other. An energy absorbing member is secured to the inner jacket and disposed adjacent the first and second anvils for transferring energy from the inner jacket to the first and second anvils during movement of the inner jacket relative to the outer jacket. The second anvil defines a longitudinal axis and includes a first locking member selectively engaging the support with the second anvil movable along the longitudinal axis and rotatable about the longitudinal axis between a plurality of positions for engaging and disengaging the first locking member with the support to facilitate the varied resistance of the second anvil.

### BACKGROUND OF THE INVENTION

1. Field of the Invention

The present invention relates to a collapsible steering column assembly for a vehicle.

2. Description of the Prior Art

Various assemblies relating to collapsible steering columns are known in the art. Such an assembly is disclosed in U.S. Pat. No. 6,769,715 (the '715 patent) to Riefe, et al. The '715 patent discloses a collapsible steering column assembly for a vehicle having an upper steering column movable when the steering column collapses. A support is secured to the upper steering column and has an energy absorbing device disposed on the support. The energy absorbing device includes a first anvil disposed within the support and secured to a stationary body of the vehicle. A plurality of second anvils are disposed on the support adjacent the first anvil. An energy absorbing member is disposed adjacent the first anvil and the second anvils for transferring energy to the first anvil and the second anvil during the collapsing of the steering column. One end of the energy absorbing member is secured to the support and the other end is free to move when the steering column collapses. However, the energy absorbing member lacks the ability to be secured within the steering column. An actuator is disposed on the support and coupled to the second anvils for adjusting the amount of resistance by the second anvils to the movement of the upper steering column relative to the stationary body during a collision. However, the energy absorbing device lacks the ability to make quick pre-assembly adjustments to the amount of resistance by the second anvil. In addition, the energy absorbing device lacks the ability to have a single second anvil for adjusting the amount of resistance.

Therefore, there remains a need to develop a collapsible steering column assembly having an energy absorbing device that provides for quick pre-assembly adjustments of a second anvil to provide varied resistance to the movement of an inner jacket relative to an outer jacket.

### SUMMARY OF THE INVENTION AND ADVANTAGES

The present invention provides for a steering column assembly having an outer jacket and an inner jacket with the inner jacket movable relative to the outer jacket for collapsing a steering column. The steering column assembly includes an energy absorbing device having a first anvil and a second anvil disposed on the outer jacket adjacent one another. The second anvil is adjustable to provide varied resistance to the movement of the inner jacket relative to the outer jacket. A support is disposed on the outer jacket for supporting the first anvil and the second anvil in relative proximity to each other. An energy absorbing member is secured to the inner jacket and movable with the inner jacket. The energy absorbing member is disposed adjacent the first anvil and the second anvil for transferring energy from the inner jacket to the first anvil and the second anvil during the movement of the inner jacket relative to the outer jacket. The second anvil defines a longitudinal axis and includes a first locking member selectively engaging the support with the second anvil movable along the longitudinal axis and rotatable about the longitudinal axis between a plurality of positions for engaging and disengaging the first locking member with the support to facilitate the varied resistance of the second anvil.

The present invention therefore provides for an energy absorbing device having a first locking member engaging a support for providing quick pre-assembly adjustments of a second anvil to vary the resistance of the second anvil which reduces manufacturing time and costs. In addition, an energy absorbing member is secured within an inner jacket which protects part of the energy absorbing member from damage. Additionally, a support is disposed on an outer jacket for protecting a first anvil, the second anvil and the energy absorbing member from damage. Further, the energy absorbing device is small in size to provide space savings around the steering column assembly due to a single second anvil being utilized to vary the resistance.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a perspective view of a collapsible steering column assembly having an energy absorbing device of a first embodiment;

FIG. 2 is a fragmented cross-sectional view of the collapsible steering column assembly before collapsing a steering column;

FIG. 3 is an exploded perspective view of the energy absorbing device of the first embodiment;

FIG. 4 is a fragmented back side perspective view of the energy absorbing device;

FIG. 5 is a fragmented bottom perspective view of the energy absorbing device having a flexible flange of the first embodiment;

FIG. 6 is a fragmented front side view of the energy absorbing device of the first embodiment;

FIG. 7 is a fragmented cross-sectional view of the collapsible steering column assembly after collapsing the steering column;

FIG. 8 is a fragmented front side view of the energy absorbing device having an actuator of an alternative embodiment;

FIG. 9 is an exploded perspective view of an energy absorbing device of a second embodiment;

FIG. 10 is a fragmented bottom perspective view of the energy absorbing device having a flexible flange of the second embodiment; and

FIG. 11 is a fragmented side view of the energy absorbing device of the second embodiment.

### DETAILED DESCRIPTION OF THE INVENTION

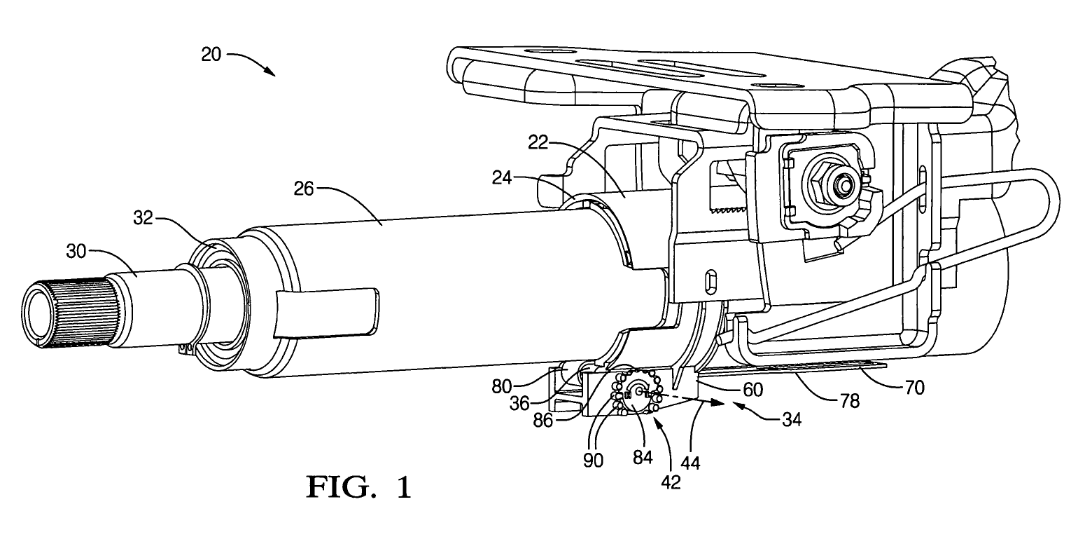

Referring to the Figures, wherein like numerals indicate like or corresponding parts throughout the several views, a collapsible steering column assembly 20 for a vehicle (not shown) is generally shown in FIGS. 1-7.

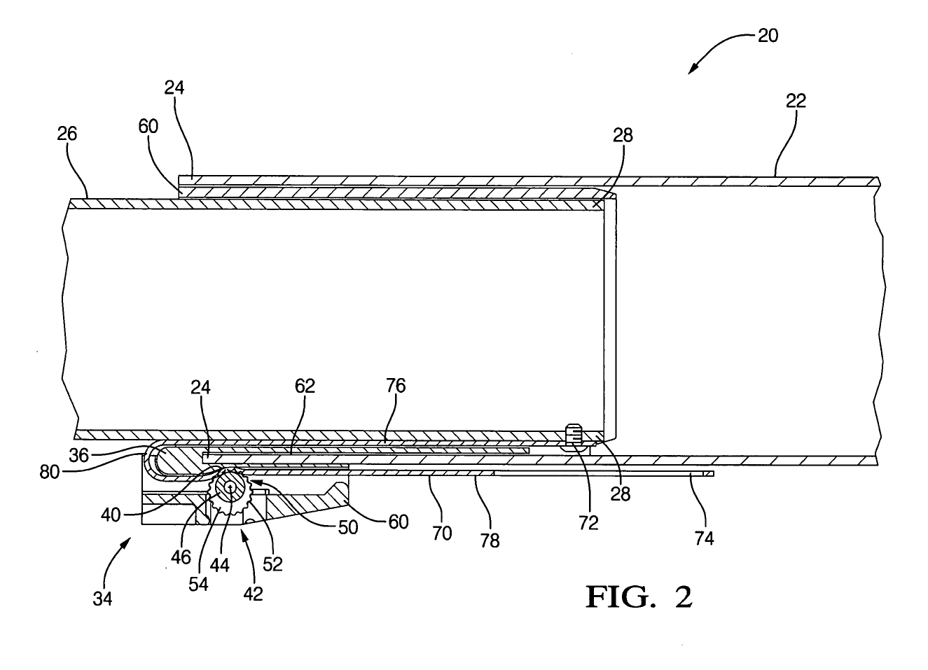

Referring to FIGS. 1 and 2, the collapsible steering column assembly 20 includes an outer jacket 22 having a distal end 24 and an inner jacket 26 having an end surface 28 with the inner jacket 26 movable relative to the outer jacket 22 for collapsing a steering column. More specifically, the end surface 28 of the inner jacket 26 is disposed within the distal end 24 of the outer jacket 22. An upper shaft 30 extends through the inner jacket 26 and includes a bearing 32 attached to the upper shaft 30 and the inner jacket 26 so when the vehicle is in a collision, the upper shaft 30 and the inner jacket 26 move together within the outer jacket 22. FIG. 2 illustrates the collapsible steering column assembly 20 before the vehicle is in the collision. A steering wheel (not shown) is attached to the upper shaft 30 and when the vehicle is in the collision, a driver applies a force to the steering wheel which causes the upper shaft 30 and the inner jacket 26 to move together within the outer jacket 22.

The collapsible steering column assembly 20 further includes an energy absorbing device, generally shown at 34, having a first anvil 36 disposed on the outer jacket 22 and defining a curved profile. The first anvil 36 includes a shoulder 40 spaced from the curved profile. The energy absorbing device 34 further includes a second anvil, generally shown at 42, defining a longitudinal axis 44 and disposed on the outer jacket 22 adjacent the first anvil 36. The energy absorbing device 34 is small in size to provide space savings around the steering column due to the single second anvil 42 being utilized to vary the resistance. The second anvil 42 is adjustable to provide varied resistance to the movement of the inner jacket 26 relative to the outer jacket 22.

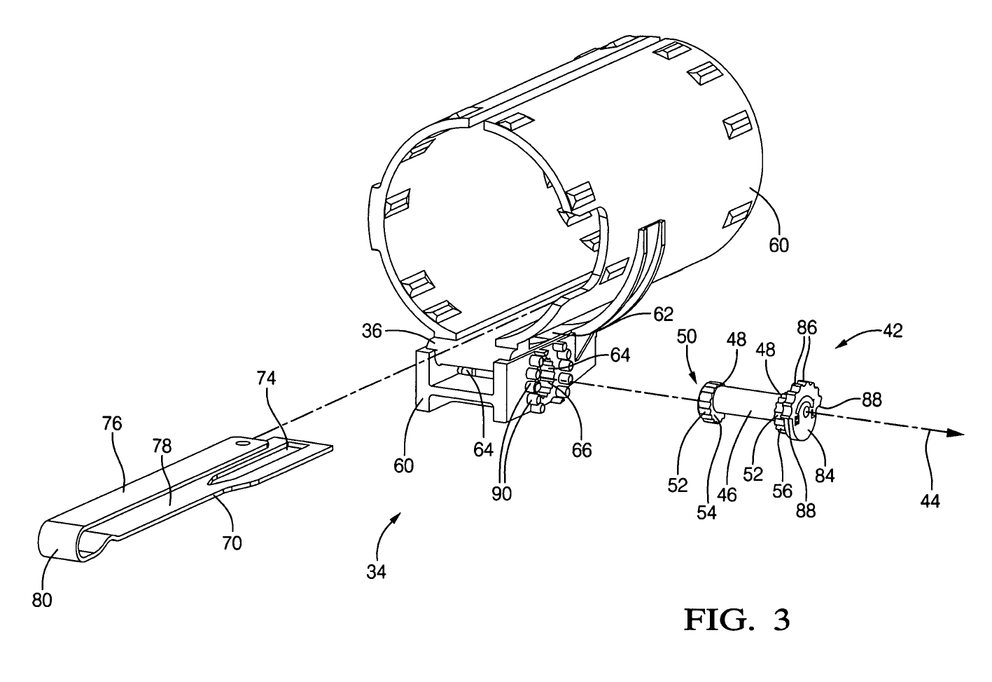

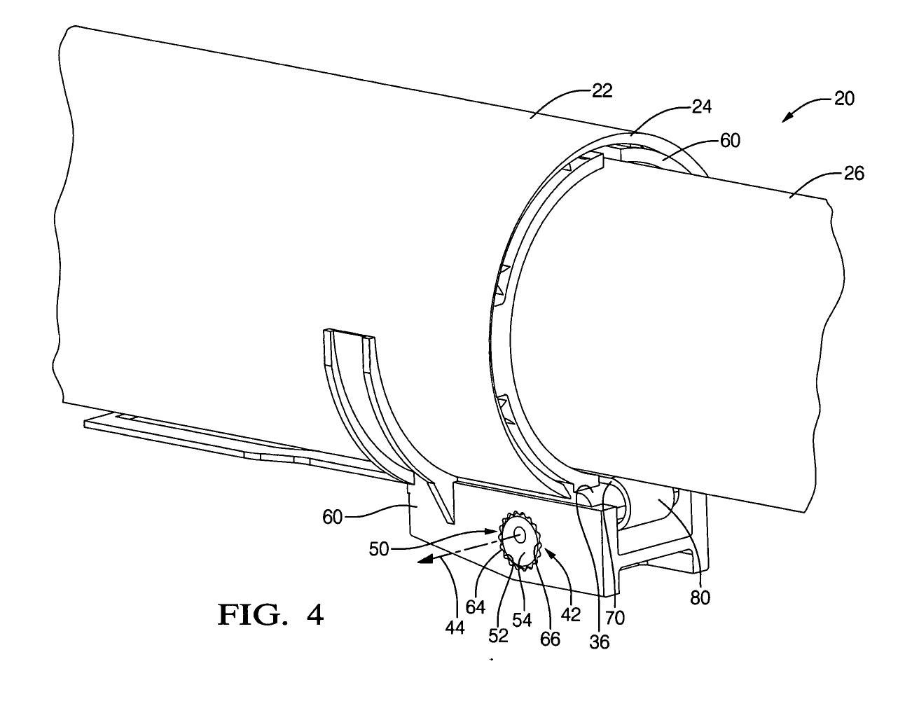

Also referring to FIGS. 3 and 4, the second anvil 42 includes a body portion 46 having opposing ends 48 with the longitudinal axis 44 extending along the body portion 46. A plate, generally shown at 50, having a plurality of ribs 52 and defining a circumference, is disposed on one of the ends 48 of the second anvil 42. The plate 50 may be further defined as a first end plate 54 disposed on one of the ends 48 of the second anvil 42 and a second end plate 56 disposed on the other end 48 of the second anvil 42 with the ribs 52 extending from each of the first end plate 54 and the second end plate 56. The body portion 46 is disposed offset from the circumference to define an eccentric profile, as best shown in FIG. 2, for providing varied resistance of the second anvil 42. It is contemplated that the body portion 46 may be centered on the circumference with the body portion 46 having a non-circular outer surface. However, it is to be appreciated that any suitable profile may be disposed on the second anvil to provide varied resistance. When the second anvil 42 is rotated about the longitudinal axis 44, the eccentric profile rotates to provide small to large changes in the resistance of the second anvil 42.

A support 60 is adapted to be mounted to the steering column. More specifically, the support 60 is disposed on the outer jacket 22 for supporting the first anvil 36 and the second anvil 42 in relative proximity to each other. The second anvil 42 is movably mounted to the support 60 and adjustable to provide varied resistance to the movement of the inner jacket 26 relative to the outer jacket 22. The support 60 aids in protecting the first anvil 36 and the second anvil 42 from damage. Preferably, the first anvil 36 and the support 60 are formed of a homogenous material. Even more preferably, the first anvil 36 and the support 60 are formed of a one-piece integrated plastic material or a one-piece integrated polymeric material. However it is to be appreciated that the first anvil 36 and the support 60 may be formed of nylon or any other acceptable material known to those of ordinary skill in the art.

The support 60 defines a slot 62 for receiving the distal end 24 of the outer jacket 22 to aid in positioning the support 60 relative to the outer jacket 22. The support 60 further defines a plurality of apertures 64 spaced apart from each other along the longitudinal axis 44. The support 60 includes a plurality of protrusions 66 extending toward the longitudinal axis 44 within the apertures 64 of the support 60 for mating with the ribs 52 of the plate 50 to prevent rotation of the second anvil 42 about the longitudinal axis 44. More specifically, the first end plate 54 and the second end plate 56 are disposed in corresponding apertures 64 of the support 60 with the ribs 52 of each of the first end plate 54 and the second end plate 56 mating with the protrusions 66 of each of the apertures 64 to prevent rotation of the second anvil 42 about the longitudinal axis 44. Preferably, the protrusions 66 and the support 60 are formed of a homogenous material. Even more preferably, the protrusions 66 and the support 60 are formed of a one-piece integrated plastic material or a one-piece integrated polymeric material. However it is to be appreciated that the protrusions 66 and the support 60 may be formed of nylon or any other acceptable material known to those of ordinary skill in the art.

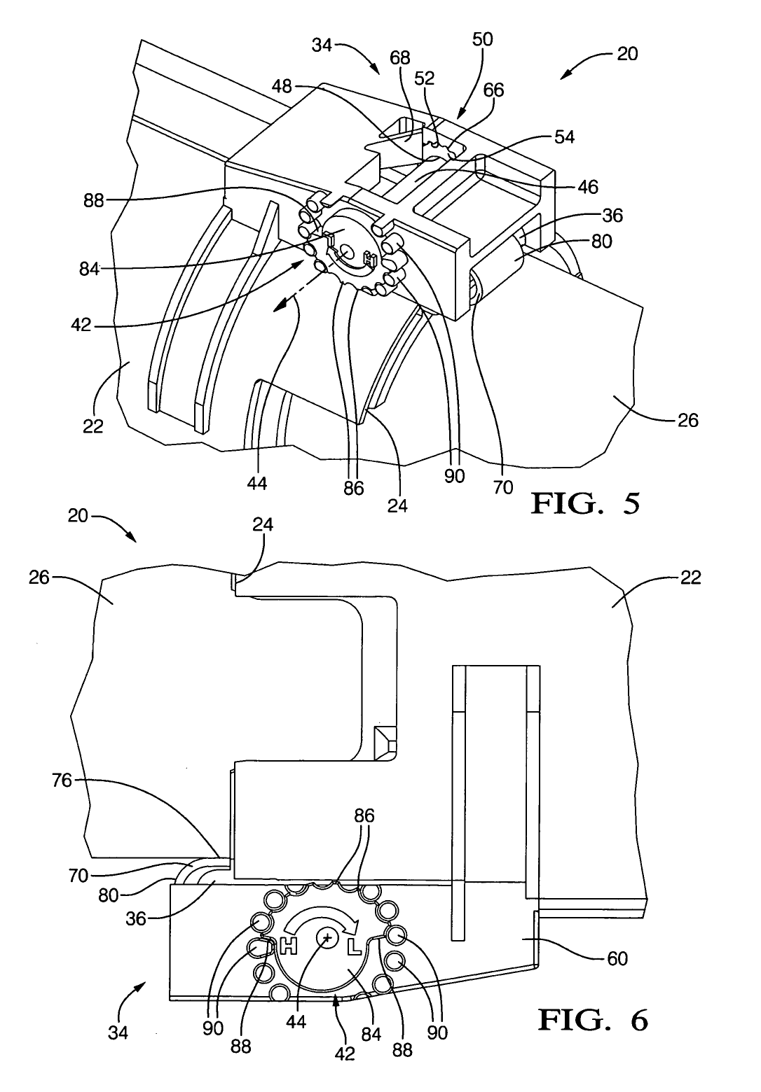

Referring to FIG. 5, the support 60 includes a flexible flange 68 abutting the second anvil 42 to selectively prevent movement of the second anvil 42 along the longitudinal axis 44. Even more preferably, the flexible flange 68 abuts the plate 50 of the second anvil 42 to prevent movement of the second anvil 42 along the longitudinal axis 44. Most preferably, the flexible flange 68 abuts the first end plate 54 of the second anvil 42 to prevent movement of the second anvil 42 along the longitudinal axis 44. The flexible flange 68 may be pressed to move the flexible flange 68 away from the plate 50 for allowing movement of the second anvil 42 along the longitudinal axis 44.

As best shown in FIGS. 2 and 3, an energy absorbing member 70 is secured to the inner jacket 26 and movable with the inner jacket 26. More specifically, a fastener 72 secures the energy absorbing member 70 to the end surface 28 of the inner jacket 26. The energy absorbing member 70 defines an elongated hole 74 for inserting the fastener 72 through the hole 74 to easily secure the fastener 72 to the energy absorbing member 70 and the inner jacket 26. The energy absorbing member 70 is disposed adjacent the first anvil 36 and the second anvil 42 for transferring energy to the first anvil 36 and the second anvil 42 during the collapsing of the steering column. More specifically, the energy absorbing member 70 is disposed adjacent the first anvil 36 and the second anvil 42 for transferring energy from the inner jacket 26 to the first anvil 36 and the second anvil 42 during the movement of the inner jacket 26 relative to the outer jacket 22. Preferably, the energy absorbing member 70 is disposed over the first anvil 36 and disposed between the shoulder 40 and the body portion 46 of the second anvil 42.

The energy absorbing member 70 further includes a first portion 76 and a second portion 78 spaced from each other to define a u-shaped portion 80 disposed about the curved profile of the first anvil 36. The first portion 76 is disposed on one side of the first anvil 36 and the second portion 78 is disposed on an opposing side of the first anvil 36. Preferably, the first portion 76 of the energy absorbing member 70 is secured to the end surface 28 of the inner jacket 26 by the fastener 72. The second anvil 42 is spaced from the first anvil 36 and engages the second portion 78 of the energy absorbing member 70 for allowing the energy absorbing member 70 to initially absorb energy transferred by the inner jacket 26 to the first anvil 36 and continue to absorb energy by both the first anvil 36 and the second anvil 42 as the inner jacket 26 continues to move within the outer jacket 22. The energy absorbing member 70 may be formed of ductile material. Preferably, the energy absorbing member 70 is formed of a metallic material. Even more preferably, the energy absorbing member 70 is formed of steel. However, it is to be appreciated that the energy absorbing member 70 may be formed of any other acceptable material known to those of ordinary skill in the art.

Referring to FIGS. 1 and 3-6, the second anvil 42 includes a first locking member selectively engaging the support 60 with the second anvil 42 movable along the longitudinal axis 44 and rotatable about the longitudinal axis 44 between a plurality of positions for engaging and disengaging the first locking member with the support 60 to facilitate the varied resistance of the second anvil 42. The first locking member selectively engages the support 60 for providing quick pre-assembly adjustments of the second anvil 42 to provide varied resistance of the second anvil 42. It is contemplated that the second anvil 42 may be locked into the pre-assembly position by an adhesive, a fastener, welding, or any other acceptable way known to those of ordinary skill in the art to prevent tampering of the second anvil 42.

The first locking member is disposed on at least one of the ends 48 of the body portion 46. The first locking member may be further defined as a face plate 84 having a plurality of teeth 86. Also, the first locking member may be defined as the plate 50 with the ribs 52 as set forth above. The face plate 84 abuts the support 60 to prevent movement of the second anvil 42 in one direction along the longitudinal axis 44 and allow movement of the second anvil 42 in an opposite direction along the longitudinal axis 44. The face plate 84 further provides for an easy way to grip the second anvil 42 to move the second anvil 42 along the longitudinal axis 44 and rotate the second anvil 42 about the longitudinal axis 44 to engage and disengage the first locking member with the support 60. It is contemplated that the face plate 84 may be disposed on one of the ends 48 of the body portion 46 or disposed on the second end plate 56 (as shown in FIG. 3). The face plate 84 may include a pair of ledges 88 spaced apart from each other for providing a pair of stop positions to signify a minimum resistance of the second anvil 42 and a maximum resistance of the second anvil 42. The face plate 84 and the plate 50 move in unison along the longitudinal axis 44 and about the longitudinal axis 44 for simultaneous engaging and disengaging the teeth 86 of the face plate 84 and the ribs 52 of the plate 50 with the support 60. When the teeth 86 of the face plate 84 and the ribs 52 of the plate 50 are disengaged from the support 60, the second anvil 42 is rotated about the longitudinal axis 44 to rotate the eccentric profile to provide small to large changes in the resistance of the second anvil 42. Once the desired position of the second anvil 42 is achieved, the second anvil 42 moves along the longitudinal axis 44 to re-engage the teeth 86 of the face plate 84 and the ribs 52 of the plate 50 with the support 60.

A second locking member is disposed on the support 60 adjacent the first locking member for cooperating with the first locking member to prevent rotation of the second anvil 42 about the longitudinal axis 44. The second locking member may be further defined as at least one tab 90 extending from the support 60 for cooperating with the teeth 86 of the face plate 84 to prevent rotation of the second anvil 42 about the longitudinal axis 44. Also, the second locking member may be defined as the protrusions 66 extending toward the longitudinal axis 44 within the apertures 64 of the support 60 for mating with the ribs 52 of the plate 50 to prevent rotation of the second anvil 42 about the longitudinal axis 44 as set forth above. Preferably, the tab 90 and the support 60 are formed of a homogenous material. Even more preferably, there are a plurality of tabs 90 with the tab 90 and the support 60 formed of a one-piece integrated plastic material or a one-piece integrated polymeric material. However it is to be appreciated that the tab 90 and the support 60 may be formed of nylon or any other acceptable material known to those of ordinary skill in the art. It is to be appreciated that one of the tabs 90 may be configured in any shape for abutting one of the ledges 88 of the face plate 84 when the second anvil 42 is rotated to one of the stop positions.

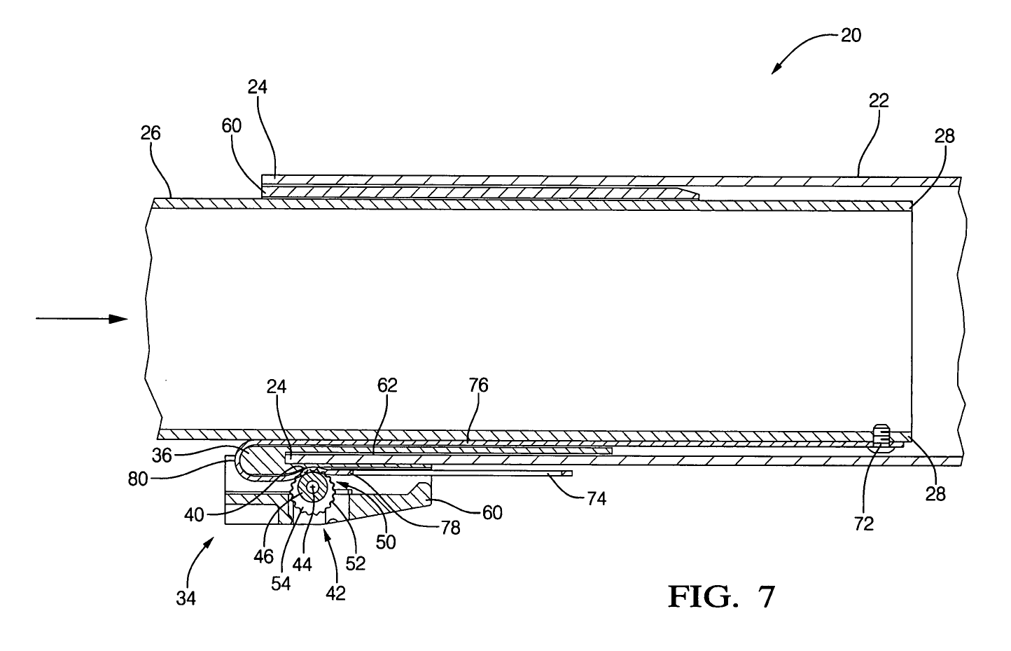

As shown in FIG. 7 when the vehicle is in the collision, the force applied to the steering wheel from the driver causes the upper shaft 30 and the inner jacket 26 to move relative to the outer jacket 22. The energy absorbing member 70 initially absorbs energy transferred by the inner jacket 26 to the first anvil 36 and continues to absorb energy by both the first anvil 36 and the second anvil 42 as the inner jacket 26 continues to move within the outer jacket 22. In other words, the first portion 76 of the energy absorbing member 70 moves over the first anvil 36 for absorbing energy transferred from the inner jacket 26 during the movement of the inner jacket 26 relative to the outer jacket 22. As the first portion 76 continues to absorb energy, the second portion 78 of the energy absorbing member 70 moves over the second anvil 42, the shoulder 40 of the first anvil 36 and the curved profile of the first anvil 36 for absorbing energy transferred from the inner jacket 26 during the movement of the inner jacket 26 relative to the outer jacket 22.

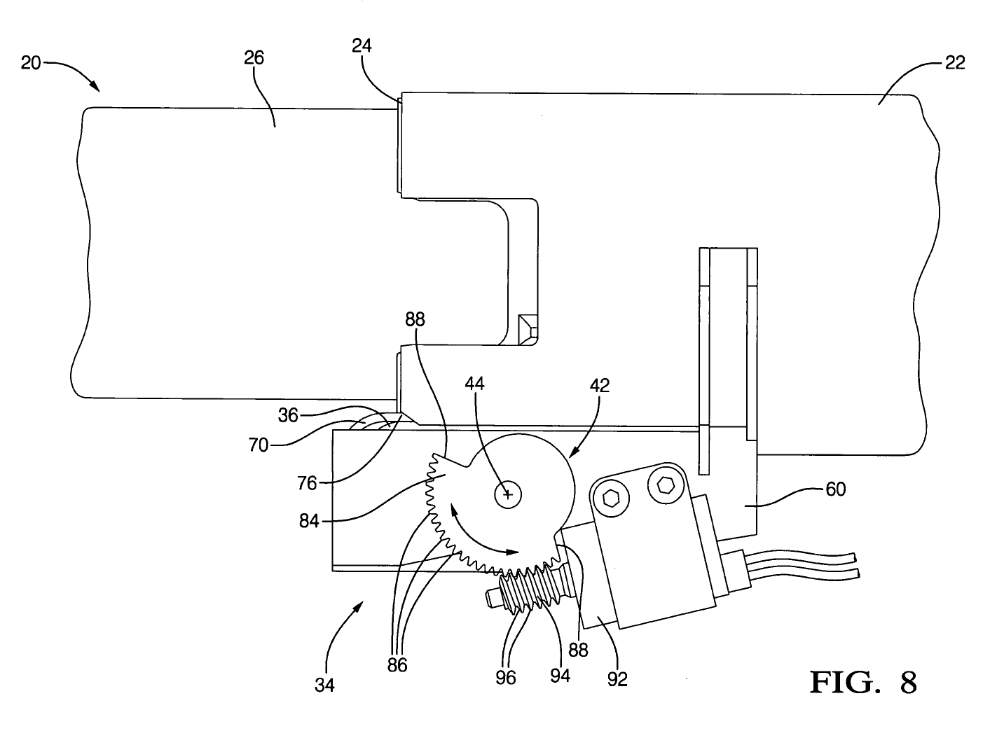

Alternatively, as shown in FIG. 8, an actuator 92 may be disposed on the support 60 for rotating the second anvil 42 between a plurality of positions to provide varied resistance to the movement of the inner jacket 26 relative to the outer jacket 22 when the vehicle is in the collision. The second locking member of this embodiment may be coupled to the actuator 92 and cooperate with the teeth 86 of the face plate 84. In this embodiment the teeth 86 of the face plate 84 are smaller and closer together and the tabs 90 of the support 60 are eliminated. Preferably, the second locking member is further defined as a gear 94 having a plurality of serrations 96 for cooperating with the teeth 86 of the face plate 84. The gear 94 may be defined as a worm gear having the serrations 96 or any other acceptable gear known to those of ordinary skill in the art for cooperating the serrations 96 with the teeth 86 of the face plate 84.

A sensor (not shown) may be in electrical communication with the actuator 92 for activating the actuator 92 to rotate the second anvil 42 which adjusts the amount of resistance by the second anvil 42 when the vehicle is in the collision. The sensor may take into account variables such as a weight of the driver, a position of the driver relative to the steering wheel, whether the driver has a seat belt fastened, a speed of the vehicle, or any other variable that may affect how much energy the energy absorbing member 70 should absorb. The actuator 92 may be an electric motor, a solenoid, an explosive charge, or any other acceptable actuator 92 known to those of ordinary skill in the art. It is to be appreciated when utilizing the actuator 92, the ribs 52 of the plate 50 are eliminated and/or the protrusions 66 of the support 60 are eliminated to allow rotational movement of the second anvil 42 about the longitudinal axis 44 when the vehicle is in the collision.

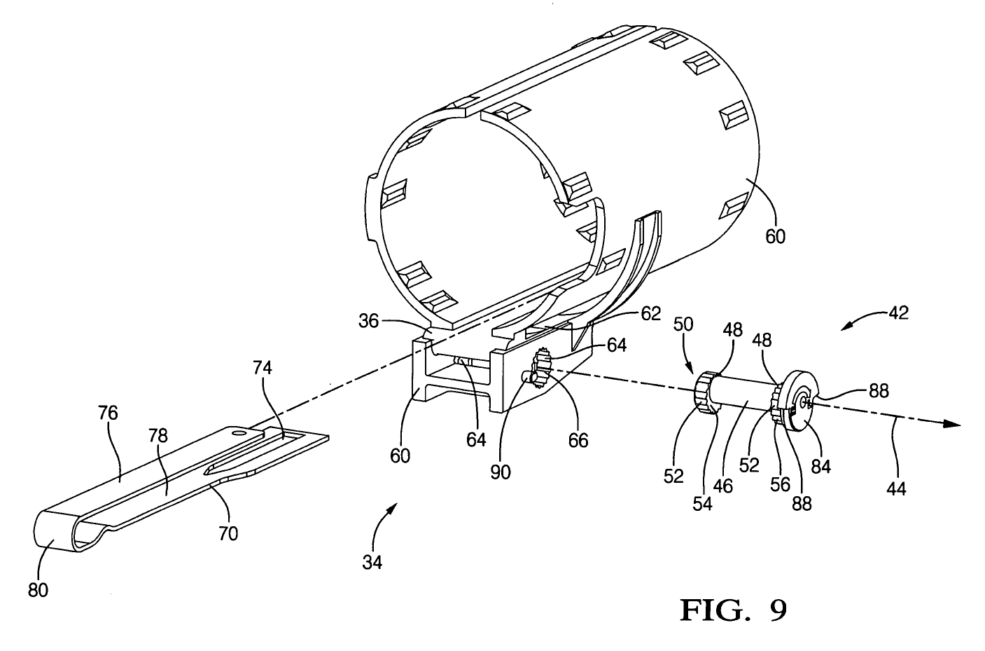

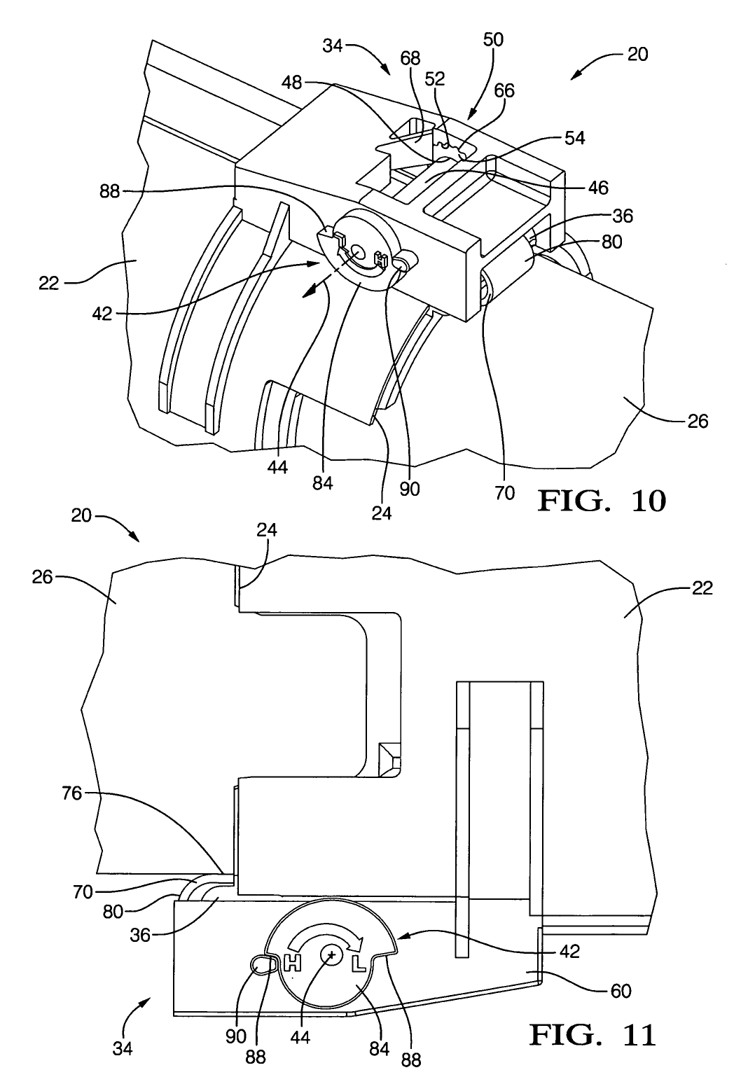

Referring to FIGS. 9-11, a second embodiment of the collapsible steering column assembly 20 for a vehicle, wherein like numerals indicate like or corresponding parts throughout the several views, is generally shown. The primary distinction between the first embodiment and the second embodiment are the configurations of the first locking member and the second locking member.

In this embodiment, the teeth 86 of the face plate 84 are eliminated and the face plate includes the ledges 88 spaced apart from each other for providing the stop positions to signify the minimum resistance of the second anvil 42 and the maximum resistance of the second anvil 42. The plurality of tabs 90 are eliminated and a single tab 90 is disposed on the support 60 for abutting one of the stop positions when the second anvil 42 is rotated to the minimum resistance of the second anvil 42 or the maximum resistance of the second anvil 42. It is to be appreciated that the tab 90 may be configured in any shape for abutting the ledges 88. The first locking member of this embodiment is defined as the plate 50 with the ribs 52 and disposed on the second anvil 42 as set forth above. The second locking member of this embodiment is further defined as the protrusions 66 extending toward the longitudinal axis 44 within the apertures 64 of the support 60 with the protrusions 66 and the ribs 52 mating with each other to prevent rotation of the second anvil 42 about the longitudinal axis 44 as set forth above.

Obviously, many modifications and variations of the present invention are possible in light of the above teachings. The foregoing invention has been described in accordance with the relevant legal standards; thus, the description is exemplary rather than limiting in nature. Variations and modifications to the disclosed embodiment may become apparent to those skilled in the art and do come within the scope of the invention. Accordingly, the scope of legal protection afforded this invention can only be determined by studying the following claims.

What is claimed is:

1. A collapsible steering column assembly for a vehicle, said assembly comprising;
an outer jacket,
an inner jacket movable relative to said outer jacket for collapsing a steering column,
a first anvil disposed on said outer jacket,
a second anvil disposed on said outer jacket adjacent said first anvil with said second anvil being adjustable to provide varied resistance to the movement of said inner jacket relative to said outer jacket, and
an energy absorbing member secured to said inner jacket and movable with said inner jacket with said energy absorbing member disposed adjacent said first anvil and said second anvil for transferring energy from said inner jacket to said first anvil and said second anvil during said movement of said inner jacket relative to said outer jacket.

2. An assembly as set forth in claim 1 further including a support disposed on said outer jacket for supporting said first anvil and said second anvil in relative proximity to each other.

3. An assembly as set forth in claim 2 wherein said first anvil defines a curved profile and said energy absorbing member includes a first portion and a second portion spaced from each other to define a unshaped portion disposed about said curved profile with said first portion disposed on one side of said first anvil and said second portion disposed on an opposing side of said first anvil.

4. An assembly as set forth in claim 3 wherein said second anvil is spaced from said first anvil and engages said second portion of said energy absorbing member.

5. An assembly as set forth in claim 2 wherein said first anvil and said support are formed of a homogenous material.

6. An assembly as set forth in claim 2 wherein said second anvil defines a longitudinal axis and includes a first locking member selectively engaging said support with said second anvil movable along said longitudinal axis and rotatable about said longitudinal axis between a plurality of positions for engaging and disengaging said first locking member with said support to facilitate the varied resistance of said second anvil.

7. An assembly as set forth in claim 6 further including a second locking member disposed on said support and adjacent said first locking member for cooperating with said first locking member to prevent rotation of said second anvil about said longitudinal axis.

8. An assembly as set forth in claim 2 further including an actuator disposed on said support for rotating said second anvil between a plurality of positions to provide varied resistance to the movement of said inner jacket relative to said outer jacket.

9. An energy absorbing device for a collapsible steering column of a vehicle, said device comprising;
a support adapted to be mounted to the steering column,
a first anvil,
a second anvil movably mounted to said support and disposed adjacent said first anvil with said second anvil defining a longitudinal axis and being adjustable to provide varied resistance,
an energy absorbing member disposed adjacent said first anvil and said second anvil for transferring energy to said first anvil and said second anvil during a collapsing of a steering column, and
said second anvil having a first locking member selectively engaging said support with said second anvil movable along said longitudinal axis and rotatable about said longitudinal axis between a plurality of positions for engaging and disengaging said first locking member with said support to facilitate the varied resistance of said second anvil.

10. A device as set forth in claim 9 further including a second locking member disposed adjacent said first locking member for cooperating with said first locking member to prevent rotation of said second anvil about said longitudinal axis.

11. A device as set forth in claim 10 wherein said second locking member is disposed on said support adjacent said first locking member.

12. A device as set forth in claim 9 wherein said second anvil includes a body portion having opposing ends with said longitudinal axis extending along said body portion and said first locking member disposed on at least one of said ends of said body portion.

13. A device as set forth in claim 12 further including a plate disposed on one of said ends of said second anvil and defining a circumference with said body portion offset from said circumference to define an eccentric profile for providing varied resistance of said second anvil.

14. A device as set forth in claim 11 wherein said first locking member is further defined as a face plate having a plurality of teeth and said second locking member is further defined as at least one tab extending from said support for cooperating with said teeth of said face plate to prevent rotation of said second anvil about said longitudinal axis.

15. A device as set forth in claim 14 further including a plate having a plurality of ribs and disposed on said second anvil.

16. A device as set forth in claim 15 wherein said support defines a plurality of apertures spaced apart from each other along said longitudinal axis and having a plurality of protrusions extending toward said longitudinal axis within said apertures of said support for mating with said ribs of said plate to prevent rotation of said second anvil about said longitudinal axis.

17. A device as set forth in claim 11 wherein said first locking member is further defined as a plate having a plurality of ribs and disposed on said second anvil.

18. A device as set forth in claim 17 wherein said support defines a plurality of apertures spaced apart from each other along said longitudinal axis and said second locking member is further defined as a plurality of protrusions extending toward said longitudinal axis within said apertures of said support for mating with said ribs of said plate to prevent rotation of said second anvil about said longitudinal axis.

19. A device as set forth in claim 18 wherein said plate is further defined as a first end plate and a second end plate spaced from each other and disposed on said second anvil with said first end plate and said second end plate disposed in corresponding apertures of said support.

20. A device as set forth in claim 9 wherein said support includes a flexible flange abutting said second anvil to selectively prevent movement of said second anvil along said longitudinal axis.
